(19) United States
(12) Patent Application Publication
(10) Pub. No.: US 2007/0227006 A1
(43) Pub. Date: Oct. 4, 2007

(54) Shaving systems with exfoliation

(75) Inventors: Gregory D. Aviza, Marlborough, MA (US); William E. Tucker, Attleboro, MA (US); Robert A. Trotta, Pembroke, MA (US)

Correspondence Address: THE PROCTER & GAMBLE COMPANY;INTELLECTUAL PROPERTY DIVISION - WEST BLDG., WINTON HILL BUSINESS CENTER - BOX 412, 6250 CENTER HILL AVENUE, CINCINNATI, OH, 45224, US

(73) Assignee: The Gillette Company

(21) Appl. No.: 11/805,438

(22) Filed: May 23, 2007

Related U.S. Application Data
(62) Division of application No. 10/830,383, filed on Apr. 22, 2004, now abandoned.

(51) Int. Cl. B26B 21/10

(52) U.S. Cl. 30/41

(57) ABSTRACT

The invention features, in general, a wet-shaving system including a housing, one or more blades mounted on the housing, an exfoliation member mounted on the housing, and a drive mechanism providing repeating movement to said exfoliation member.

This application is a divisional of U.S. application Ser. No. 10/830,383, filed Apr. 22, 2004, pending.

### TECHNICAL FIELD

This invention relates to shaving systems with exfoliation.

### BACKGROUND

Shaving razors used in wet shaving systems typically have one or more blades on a housing. The surface contacted by the skin in front of the blades is known as the guard, and the surface contacted by the skin after the blades is known as the cap. In many wet shaving systems, the guard has elastomeric projections to engage and stretch the skin before contacting the cutting edges of the blades, and the cap provides a lubricating agent to the skin surface after contacting the blades.

It is also known to enhance the tactile properties of a wet-shaving system. For example, Lyall U.S. Pat. No. 3,939,560 discloses shaving equipment with a roughened guard surface. The guard surface in Lyall can be roughened by abrading it with particles or, alternatively, by coating or impregnating it with particles.

### SUMMARY

The invention features, in general, a wet-shaving system including a housing, one or more blades mounted on the housing, an exfoliation member mounted on the housing, and a drive mechanism providing repeating movement to the exfoliation member.

Preferred embodiments of the invention may include one or more of the following features. In preferred embodiments the exfoliation member is located in front of the blades. An elastomeric guard member can be located between the exfoliation member and the blades. The elastomeric guard member can include projections, e.g., elongated fins. A guard bar can be located between the exfoliation member and the blades. The exfoliation member can be elongated and oriented parallel to the blades. Elastomeric projections can also be located in front of the exfoliation member. Alternatively the exfoliation member can located behind the blades. The exfoliating member can be made of abrasive containing material, fibers, a brush, a wire mesh, a roughened metal surface, natural organic materials, or chemical exfoliants. The shaving system can also include a handle connected to the housing. The drive mechanism can provides repeated movement of the housing that is transmitted to the exfoliation member and the blade member. The drive mechanism can be located on the housing or within the handle. The drive mechanism can provide vibrations to the housing (directly or indirectly) that are then transmitted to the exfoliation member. Alternatively the drive mechanism can cause the exfoliation member to move relative to the housing, e.g., back and forth laterally in a linear track, or back and forth vertically with respect to the housing or in an orbital manner. When moving laterally, two elongated exfoliation members can be employed and caused to move in opposite directions. For lateral movement, the drive mechanism can include an oscillating shaft, and a crank that has one end connected to the shaft and another end operatively engaging the exfoliation member to cause it to move back and forth within the track. The shaving system preferably includes a pivotal mounting for the housing, permitting the housing to pivot during shaving. The drive mechanism preferably provides repeating movement of the exfoliation member having an amplitude of 5 mm or less, most preferably 1-3 mm. The drive mechanism preferably provides repeating movement of the exfoliation member having a frequency of less than 500 Hz. The shaving system can include a variable speed control to control the frequency of repeating movement of the exfoliation member, e.g., between 0 and 160 Hz.

Embodiments can include one or more of the following advantages. The exfoliation member removes dead skin cells, providing a smoother skin surface and more efficient hair removal by the blades. The use of exfoliation member also results in healthier looking skin and increases blood flow just under the skin. Use of a powered device provides improved comfort and better shave performance. Vibration may desensitize the skin and mask some of the discomfort associated with using an exfoliation member, permitting increased particle aggressiveness. In addition, the additional movement increases effectiveness of the exfoliation member since the exfoliating action and coverage will be greater than is obtained by a simple shaving stroke. Powered lateral motion increases effectiveness by providing multiple strokes during shaving.

Other features and advantages of the invention will be apparent from the description and drawings, and from the claims.

### DESCRIPTION OF DRAWINGS

FIG. 1 is a perspective view of a wet shaving system with exfoliation.

FIG. 2 is an exploded vertical sectional view showing the components of the cartridge of the FIG. 1 wet shaving system.

FIG. 3 is a partial sectional view of an alternative embodiment of a guard of the FIG. 2 cartridge.

FIG. 4 is a partial sectional view of a further alternative embodiment of a guard of the FIG. 2 cartridge.

FIG. 5 is a diagrammatic elevation of an alternative embodiment of a wet shaving system.

FIG. 6 is a perspective view of components of the FIG. 5 wet shaving system.

FIG. 7 is a partial plan view showing components of the FIG. 5 wet shaving system.

FIG. 8 is a partial plan view showing components of an alternative embodiment of a wet shaving system.

### DETAILED DESCRIPTION

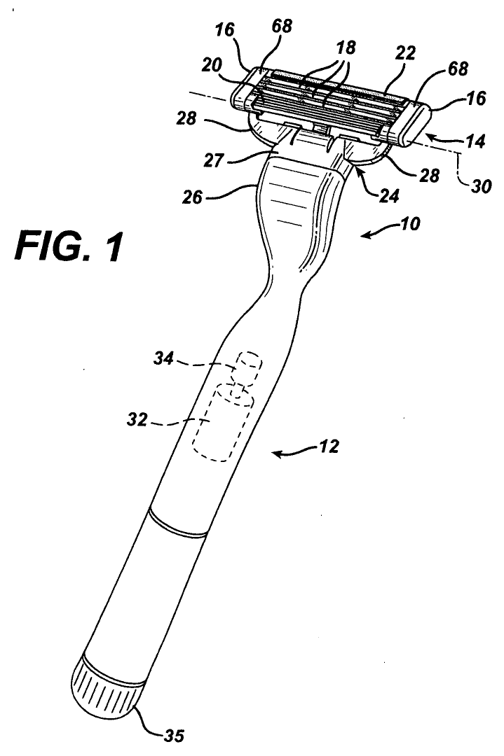

Referring to FIG. 1, shaving razor 10 includes handle 12 and replaceable shaving cartridge 14. Cartridge 14 includes housing 16, which carries three blades 18, guard 20 and cap 22. Cartridge 14 also includes interconnect member 24 on which housing 16 is pivotally mounted. Interconnect member 24 includes base 27, which removably and fixedly attaches to cartridge connecting structure (not shown) at the end 26 of handle 12, and two arms 28 that pivotally support housing 16 at its two sides for rotation about axis 30. The structure of handle 12 and cartridge 14 are generally described in U.S. Pat. Nos. 5,787,586 and 5,956,851, which are hereby incorporated by reference.

Handle 10 includes internal motor 32 and eccentric member 34 to provide vibrations to the handle which are in turn transmitted to the housing 16 of cartridge 14 and the components mounted on the housing. Such a motor and eccentric member are described in U.S. Pat. No. 5,299,354, which is hereby incorporated by reference. Handle 10 also includes control knob 34 that controls the revolutions per minute of motor 32.

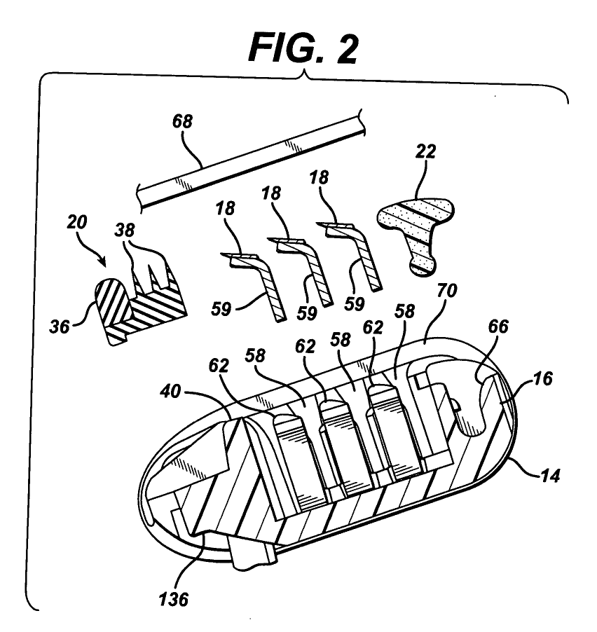

Referring to FIGS. 1 and 2, housing 16 of cartridge 14 has inwardly facing slots 58 in sidewalls 60 for receiving the edges of the base portions 59 of blades 18 and respective resilient arms 62 on which each blade 18 is resiliently supported. Clips 68 are secured at the respective sides of housing 16 inside of raised edges 70 of sidewalls 60 in order to retain blades 18 within housing 16 and to locate the cutting edges of the spring-biased blades at a desired exposure. Cap 22 can provide a lubricous shaving aid (alternatively cap 22 can be an exfoliation member, as described in more detail below) and is received in slot 66 at the rear of housing 16. Cap 22 may be made of a material comprising a mixture of a hydrophobic material and a water leachable hydrophilic polymer material, as is known in the art and is described, e.g., in U.S. Pat. Nos. 5,113,585 and 5,454,164, which are hereby incorporated by reference.

Referring to FIG. 2, guard 20, at the front of housing 16, includes exfoliation member 36 and elastomeric fins 38, both of which extend along the length of the housing 16, in front of guard bar 40. Elastomeric fins 38 engage and stretch the user's skin; other skin engaging protrusions, e.g., as described in U.S. Pat. No. 5,191,712, which is hereby incorporated by reference, can be used.

Exfoliation is generally described as the peeling off of flakes or scales of dead skin. Exfoliation member 36 can be made of, for example, a mounted abrasive (e.g., sandpaper), a composite containing engineered fibers, a brush (with or without abrasive elements on the brush fibers), a molded surface (e.g., a roughened molded surface), wire mesh, a roughened (e.g., etched) metal surface, stone or stone-like material (e.g., pumice), individual fingers (e.g., plastic fingers), individual knobs, a spray- or dip-coated surface, flocked foam, a woven surface (e.g., terrycloth), or the hook and/or loop component of a hook-and-loop fastener (e.g., a Velcro™ fastener). The exfoliation member 36 can have any texture that is suitable for exfoliation. The exfoliation member can have a relatively smooth exfoliating texture, such as the texture of a fine non-woven fiber, or it can have a relatively rough exfoliating texture, such as the texture of a pumice stone. The exfoliating elements in the exfoliation member can be any of a number of different types of exfoliating elements. For example, the exfoliating elements can include abrasive particles, such as ground fruit seeds and stones (e.g., apricot, peach, avocado, or olive seeds or stones), ground nut shells (e.g., walnut, almond, coconut, or pecan shell), ground or fibrous plant material (e.g., loofah, corn cob, oatmeal), polymer beads or granular polymers (e.g., polystyrene beads, polyethylene beads), Jojoba wax beads, rice bran, silica, minerals, granular mineral composites (e.g., sand, pumice sand), clay, or combinations thereof. The exfoliating elements can be dissolvable. The exfoliating elements can be materials (e.g., sea salt) that are abrasive upon first contact with the user's skin, but that later dissolve upon contact with water or shave creams and gels. In some cases, the exfoliating elements may include chemical exfoliants such as alpha- or beta-hydroxy acids (e.g., citric acid, lactic acid, glycolic acid, tartaric acid). In such cases, the chemical exfoliants can be contained in a microcapsule that breaks during shaving, thereby releasing the exfoliant. In this case, it is generally desirable to use a matrix material that erodes or dissolves during shaving, so that new microcapsules will be exposed to replace those that have ruptured. Suitable microcapsules can range in size from less than about 50 microns to about 1000 microns. Microencapsulation can help to protect the exfoliant, e.g., by protecting heat-sensitive acids from decomposition during extruding or molding operations. Generally, suitable exfoliating elements have a hardness, roughness, and/or tackiness that is sufficient to allow the exfoliating element to remove loose flakes of skin during shaving. The exfoliating elements can be sufficiently hard so that they do not break down during shaving, or may be softer if desired.

The exfoliation member can have a width of between about 2 mm and about 10 mm, and a length the extends along the majority of the length of housing 16. The height of the exfoliation pad relative to a plane through the cutting edges could be fixed or could be adjustable, as described in U.S. application Ser. No. 10/732,555, filed Dec. 10, 2003, which is hereby incorporated by reference.

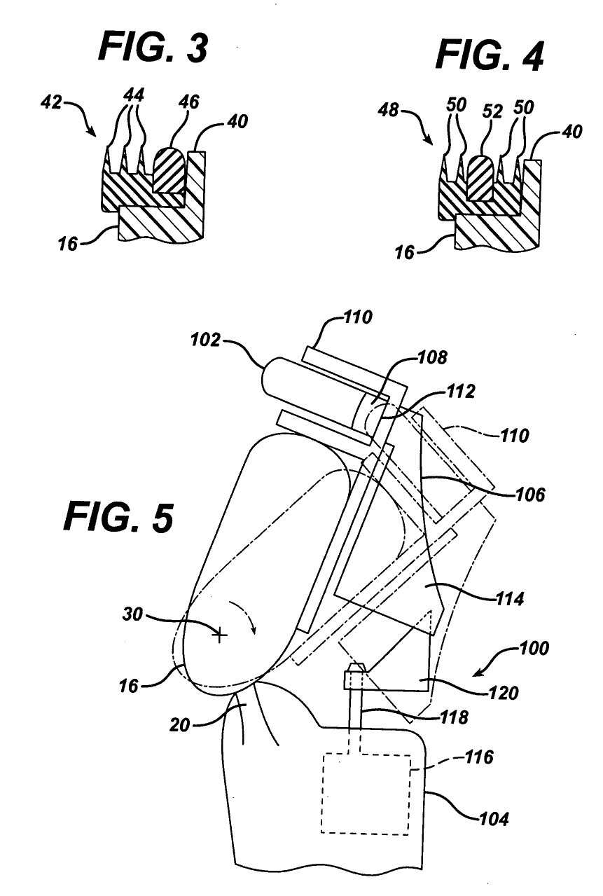

FIGS. 3 and 4 show alternative embodiments for guard 20. In FIG. 3, guard 42 has three fins 44 in front of exfoliation member 46. In FIG. 4, guard 48 has two fins 50 in front of exfoliation member 52 and two fins 50 behind exfoliation member 52.

In another embodiment, cap 22 is made of an exfoliation material as described above.

When using razor 10, the user turns on the vibrating motor and selects the desired operating frequency by rotating knob 34. The user then shaves using normal shaving strokes. Fins 38, 44 or 50 engage and stretch the skin in front of the blades, and cap 22 provides lubrication. Exfoliating member 36, 46 or 52 tends to remove dead skin cells with each stroke and provide a smoother skin surface prior to contact by blades 18, providing more efficient hair removal by blades 18. Within handle 12, the rotation of eccentric member 34 causes the end 26 of handle 12 to vibrate. These vibrations are in turn transmitted to housing 16 and to guard 20 (including the exfoliation member 36, 46 or 52 thereon), blades 18, and cap 22 carried thereon. Vibration may desensitize the skin and mask some of the discomfort associated with using exfoliation member 36, permitting increased particle aggressiveness. The vibrations provide improved comfort and better shave performance. The pivotal connection about axis 30 permits the housing 16 to pivot and follow the contours of the face during shaving, avoiding concern that a user might push a vibrating cartridge too hard against the skin without appreciating it, as might happen with a vibrating razor having a non-pivoting connection of a cartridge to a handle.

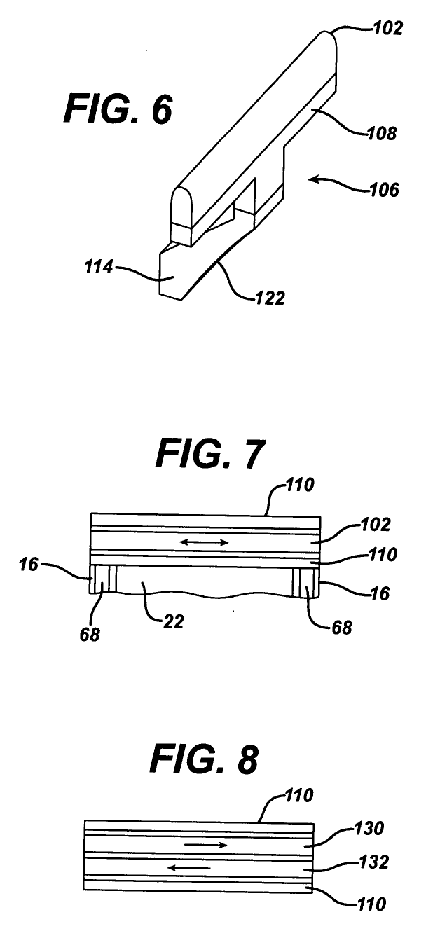

FIGS. 5-7 show an alternative razor 100 in which exfoliation member 102 is mounted for movement with respect to housing 16, which is pivotally mounted via arms 28 to a modified handle 104. Exfoliation member 102 is mounted on reciprocating shuttle 106 (see FIG. 6), which has an elongated platform 108 that slides within a track provided by walls 110 mounted at the rear of housing 16. Shuttle 106 passes through an opening in the base member 112 between walls 110 and has a slotted base portion 114 thereunder. Base member 112 is secured to housing 16. Handle 104 has an internal motor and drive system 116 that reciprocally rotates shaft 118 and extension 120 thereon through a small angle. Extension 120 sits within slot 122 of base portion 114, and reciprocating motion of extension 120 causes platform 108 and exfoliation member 102 thereon to reciprocate laterally, as indicated in FIG. 7. As housing 16 pivots about axis 30 during shaving (as indicated in phantom in FIG. 5), extension 120 remains within slot 122 and continues to provide reciprocation to exfoliation member 102. The lateral motion of exfoliation member 102 increases its effectiveness by providing multiple strokes during shaving and providing increased coverage as compared with that obtained by a simple shaving stroke.

Alternatively, exfoliation member 102 could be driven for vertical oscillations, i.e., into and out of a plane passing through the cutting edges of blades 18. Alternatively, the exfoliation member could be moved forward and backward with respect to the blades or in an orbital path.

FIG. 8 shows an alternative embodiment in which two adjacent, parallel exfoliation members 130, 132 are reciprocally driven in opposite directions (by a suitable drive system, not shown) in order to cancel out the action of a single laterally moving member tending to pull the skin to the side with respect to the housing 16.

Other embodiments are within the scope of the following claims. For example, the vibration generator can be mounted within or be directly attached to housing 16.

What is claimed is:

1. A wet-shaving system comprising:
a housing;
one or more razor blades mounted on said housing;
an exfoliation member mounted on said housing, and
a powered drive mechanism providing repeating movement to said exfoliation member, said powered drive mechanism causing said exfoliation member to move vertically with respect to said housing.

2. The system of claim 1 wherein said exfoliation member is located in front of said one or more blades.

3. The system of claim 2 further comprising an elastomeric guard member between said exfoliation member and said one or more blades.

4. The system of claim 3 wherein said elastomeric guard member comprises elastomeric projections.

5. The system of claim 4 wherein said projections comprise elongated fins.

6. The system of claim 3 further comprising a guard bar between said exfoliation member and said one or more blades.

7. The system of claim 1 wherein said exfoliation member is an elongated member that is oriented parallel to said blade.

8. The system of claim 1 wherein said exfoliation member is located behind said one or more blades.

9. The system of claim 1 wherein said exfoliating member comprises one or more members of the group consisting of abrasive containing material, fibers, a brush, a wire mesh, a roughened metal surface, natural organic materials, and chemical exfoliants.

10. The system of claim 1 further comprising a handle connected to said housing.

11. The system of claim 10 wherein said drive mechanism is located on said housing.

12. The system of claim 10 wherein said drive mechanism is located on said handle, and repeated movement of said handle is transmitted to said housing.

13. The system of claim 1 further comprising a linear track on said housing in which said exfoliation member moves back and forth.

14. The system of claim 13 wherein said drive mechanism comprises an oscillating shaft, and a crank that has one end connected to said shaft and another end operatively engaging said exfoliation member to cause it to move back and forth within said track.

15. The system of claim 1 further comprising a pivotal mounting for said housing permitting said housing to pivot during shaving.

16. The system of claim 1 further comprising a variable speed control to control the frequency of repeating movement of said exfoliation member.

17. The system of claim 1 wherein said drive mechanism provides repeating movement of said exfoliation member irrespective of whether said exfoliation member is contacting a skin surface being shaved.
